(19) United States
(12) Patent Application Publication
(10) Pub. No.: US 2004/0015255 A1
(43) Pub. Date: Jan. 22, 2004

(54) Process for the optimization of the design of an electric power train

(75) Inventor: Roy I. Davis, Saline, MI (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Corporation, Dearborn, MI

(21) Appl. No.: 10/346,553

(22) Filed: Jan. 16, 2003

Related U.S. Application Data
(60) Provisional application No. 60/319,082, filed on Jan. 16, 2002.

(51) Int. Cl. G06F 19/00

(52) U.S. Cl. 700/97

(57) ABSTRACT

A process for the optimization of the design of an electric power train system comprising a plurality of subsystems including identifying a plurality of variables associated with the plurality of subsystems of the electric power train system, wherein the plurality of variables interact, applying a plurality of constraints associated with the plurality of subsystems of the electric power train system to the plurality of variables, and manipulating the plurality of variables such that the plurality of constraints are met. The process also including identifying a plurality of cost drivers associated with the plurality of subsystems of the electric power train system, determining a plurality of weighting functions, applying the plurality of weighting functions to the plurality of cost drivers to generate a plurality of weighted cost drivers associated with the plurality of subsystems of the electric power train system, and summing the plurality of weighted cost drivers to generate a performance index associated with the electric power train system. The process further including comparing a plurality of electric power train system designs utilizing a performance index associated with each, wherein a given electric power train system design with a relatively lower performance index has a relatively lower cost.

### BACKGROUND OF INVENTION

1. Field of the Invention

The present invention relates generally to a process for the optimization of the design of an electric power train. More specifically, the present invention relates to a process for the cost optimization of the design of an electric power train comprising a plurality of subsystems, including an electric motor, a transmission, an inverter, and a controller.

2. Description of the Related Art

The power train utilized in an electric vehicle (EV), such as a battery-powered vehicle, a fuel cell vehicle, and a hybrid electric vehicle (HEV), typically comprises a plurality of complex and interacting subsystems, including an electric motor, a transmission, an inverter, and a controller. The electric motor is operable for providing torque to drive the EV, and for generating power to charge the battery or fuel cell of the EV. The electric motor may be, for example, a permanent magnet motor, a switched reluctance motor, or a field-oriented induction motor. The transmission is operable for adjusting the gear ratio of the transaxle of the EV. The inverter, also referred to as the electric power inverter or the traction inverter module (TIM), is operable for converting the raw DC current generated by the battery or fuel cell into an AC current capable of powering the electric motor. The controller includes algorithms operable for controlling the operation of the electric motor, the transmission, and the inverter, if necessary. Together, the inverter and the controller comprise an inverter/controller subsystem.

The design of a cost-optimized electric power train is a difficult task. The design of a given subsystem of the electric power train is heavily dependent upon the design of the remaining subsystems of the electric power train, and decisions made with respect to one subsystem may result in the increased cost of another subsystem. Thus, what is needed is a process for the optimization of the design of an electric power train that generates and compares the cost of a plurality of candidate electric power train designs, taking into account subsystem interactions, and allows for an overall system cost optimization, while ensuring compliance with system-level requirements. What is also needed is a process by which candidate electric power train designs may be compared on a cost basis without carrying out a plurality of detailed and expensive subsystem designs.

### BRIEF SUMMARY OF INVENTION

The present invention provides a process for the optimization of the design of an electric power train comprising an electric motor, a transmission, and an inverter/controller. This process is operable for determining a plurality of cost drivers for each of the plurality of subsystems of the electric power train and applying a plurality of weighting functions that relate the plurality of cost drivers to the total electric power train system cost. The process is also operable for capturing a plurality of electric power train system constraints, independent variables, and dependent variables such that a plurality of performance indices may be generated, allowing for a direct cost comparison of candidate electric power train designs. The process allows candidate electric power train subsystem designs to be integrated into a complete electric power train system and ranked utilizing the plurality of weighting functions such that a minimum total electric power train system cost may be achieved, while ensuring compliance with system-level requirements.

In one embodiment, a process for the optimization of the design of an electric power train system comprising a plurality of subsystems includes identifying a plurality of variables associated with the plurality of subsystems of the electric power train system, wherein the plurality of variables interact, applying a plurality of constraints associated with the plurality of subsystems of the electric power train system to the plurality of variables, and manipulating the plurality of variables such that the plurality of constraints are met. The process also includes identifying a plurality of cost drivers associated with the plurality of subsystems of the electric power train system, determining a plurality of weighting functions, applying the plurality of weighting functions to the plurality of cost drivers to generate a plurality of weighted cost drivers associated with the plurality of subsystems of the electric power train system, and summing the plurality of weighted cost drivers to generate a performance index associated with the electric power train system. The process further includes comparing a plurality of electric power train system designs utilizing a performance index associated with each, wherein a given electric power train system design with a relatively lower performance index has a relatively lower cost.

In another embodiment, a process for the optimization of the design of an electric power train system comprising a plurality of subsystems, including an electric motor, a transmission, and an inverter/controller, includes identifying a plurality of cost drivers associated with the electric motor, identifying a plurality of cost drivers associated with the transmission, and identifying a plurality of cost drivers associated with the inverter/controller. The process also includes determining a plurality of weighting functions, applying the plurality of weighting functions to the plurality of cost drivers, and summing the plurality of weighted cost drivers to generate a performance index associated with the electric power train system. The process further includes comparing a plurality of electric power train systems utilizing a plurality of performance indices, wherein a given electric power train system design with a relatively lower performance index has a relatively lower cost.

### BRIEF DESCRIPTION OF DRAWINGS

FIG. 1 is a schematic diagram of one embodiment of a process for the optimization of the design of an electric power train comprising an electric motor, a transmission, and an inverter/controller;

FIG. 2 is a flow chart of one embodiment of the process for the optimization of the design of an electric power train, including an electric power train sizing routine;

FIG. 3 is a flow chart of one embodiment of the process for the optimization of the design of an electric power train, including an electric motor subsystem design routine;

FIG. 4 is a flow chart of one embodiment of the process for the optimization of the design of an electric power train, including an inverter/controller subsystem design routine; and

FIG. 5 is a flow chart of one embodiment of the process for the optimization of the design of an electric power train, including a transmission subsystem design routine.

FIG. 6 is a schematic diagram of a computing system having a processor, a memory and user interface to perform the processes taught herein.

### DETAILED DESCRIPTION OF THE INVENTION

In the following description, certain specific details are set forth in order to provide a through understanding of various embodiments of the invention. However, one skilled in the art will understand that the invention may be practiced without these details. In other instances, well-known structures associated with electrical circuits and circuit elements have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

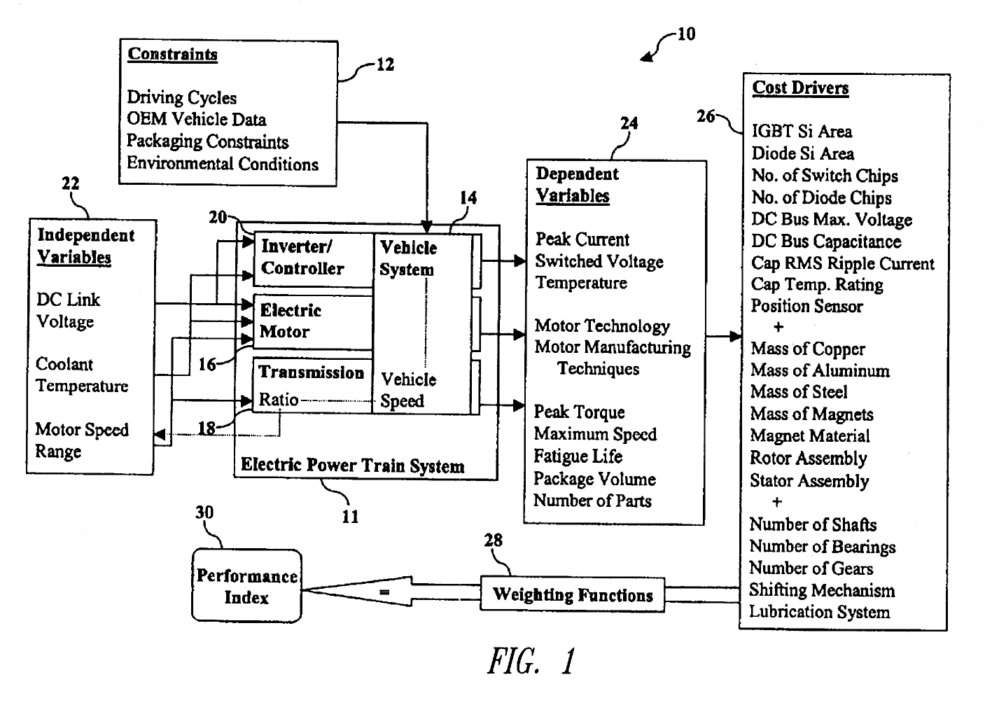

Referring to FIG. 1, in one embodiment, a process 10 for the optimization of the design of an electric power train system 11 includes identifying and capturing a plurality of electric power train system constraints 12 associated with a vehicle system 14. These constraints 12 comprise fundamental system-level electric power train performance requirements that must be met by a given candidate electric power train design. The constraints 12 may include, for example, driving cycle constraints (including acceleration constraints and grade performance constraints), original equipment manufacturer (OEM) vehicle data constraints (including mass constraints, frontal area constraints, drag coefficient constraints, and tire radius constraints), packaging constraints (including shape constraints and integration constraints), and environmental condition constraints (including maximum temperature constraints and vibration spectra constraints). The vehicle system 14 comprises a plurality of complex and interacting subsystems, including an electric motor 16, a transmission 18, and an inverter/controller 20. The process 10 also includes identifying and capturing a plurality of electric power train system independent variables 22 that each affect one or more of the subsystems comprising the electric power train system 11, and a plurality of associated electric power train system dependent variables 24. The independent variables 22 may include, for example, DC link voltage, coolant temperature, and electric motor speed range. The dependent variables 24 may include, for example, electric motor technology and electric motor manufacturing techniques for the electric motor 16; peak torque, maximum speed, fatigue life, package volume, and number of parts for the transmission 18; and peak current, switched voltage, and temperature for the inverter/controller 20. The process 10 further includes determining a plurality of cost drivers 26 associated with the electric power train system 11. These cost drivers 26 may include, for example, mass of copper, mass of aluminum, mass of steel, mass of magnets, magnet material, rotor assembly process, and stator assembly process for the electric motor 16; number of shafts, number of bearings, number of gears, shifting mechanism, and lubrication system for the transmission 18; and insulated gate bipolar transistor (IGBT) silicon (Si) area, diode Si area, number of switch chips, number of diode chips, DC bus maximum voltage, DC bus capacitance, capacitor root-mean-squared (RMS) ripple current, capacitor temperature rating, and position sensor for the inverter/controller 20. Once the plurality of cost drivers 26 have been determined, a plurality of weighting functions 28 are applied to the plurality of cost drivers 26 and a plurality of performance indices 30 are generated. Each of the plurality of performance indices 30 is a numerical value representing the relative cost of a candidate electric power train system design. It should be noted that the performance indices 30 do not represent the dollar cost of the candidate electric power train system designs. Thus, the process 10 of the present invention illustrates the impact of the independent variables 22 on electric power train system cost, while holding electric power train performance constant, and yields a relative comparison of costs for the plurality of power train designs.

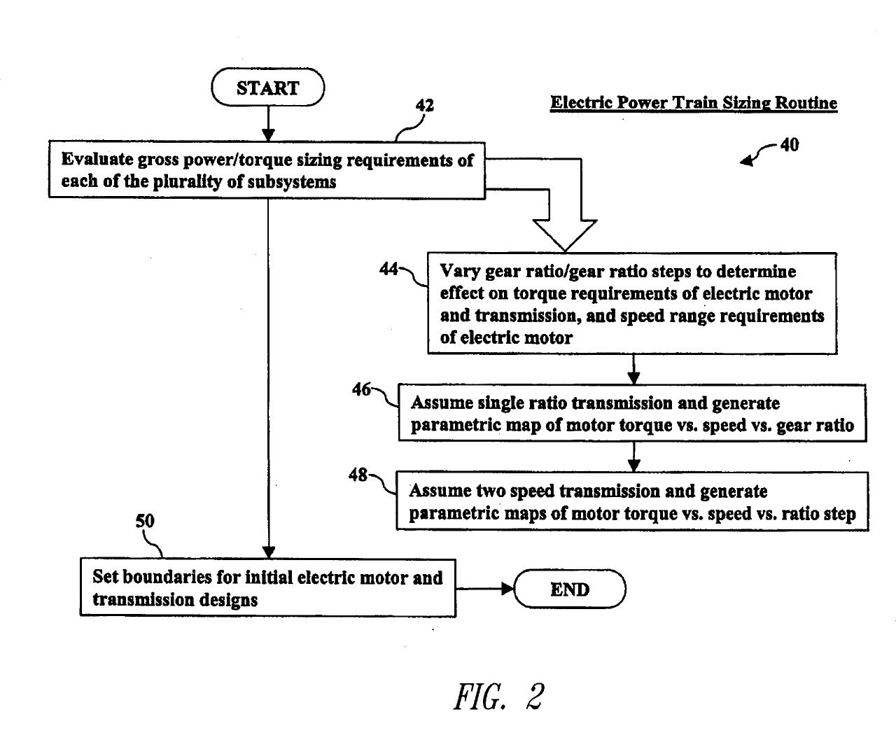

The process 10 of the present invention establishes a modular simulation environment, allowing for the free interchange of subsystems integrated with the vehicle system 14 to simulate the operation of the electric power train system 11 over a predetermined number of drive cycles. As discussed above, these subsystems may include the electric motor 16, the transmission 18, and the inverter/controller 20. Referring to FIG. 2, in one embodiment, an initial generic simulation, or electric power train sizing routine 40, is run to evaluate the gross power/torque sizing requirements of each of the plurality of subsystems (Block 42), assuming, for example, prime mover (DC source) characteristics and typical non-aggressive efficiency maps for the electric motor 16 (FIG. 1), the transmission 18 (FIG. 1), and the inverter/controller 20 (FIG. 1). In the illustrated embodiment, the gear ratio/gear ratio steps is varied to determine the effect of this parameter on the torque requirements of the electric motor 16 and the transmission 18, and the speed range requirements of the electric motor 16 (Block 44). This investigation may be carried out by assuming a single ratio transmission 18 and generating a parametric map of motor torque vs. speed vs. gear ratio (Block 46), and then assuming a two speed transmission and- generating parametric maps of motor torque vs. speed vs. ratio step (Block 48). Thus, the electric power train sizing routine 40 sets the boundaries for the initial electric motor and transmission designs (Block 50).

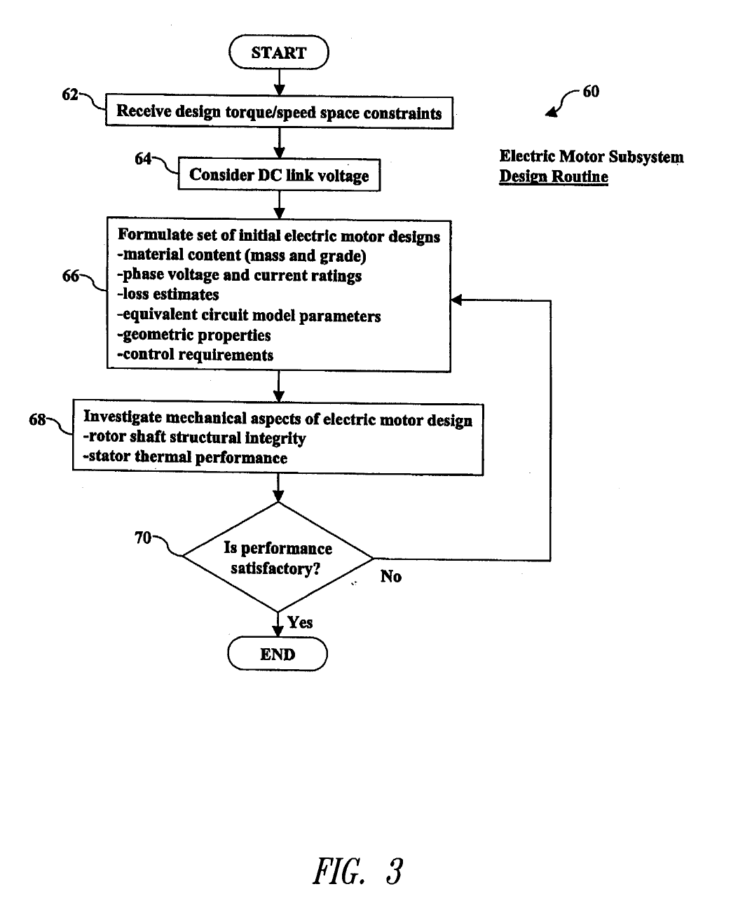

The electric power train sizing routine 40 defines a plurality of acceptable torque and speed ranges for the electric motor 16. Each of the plurality of acceptable ranges is provided by a gear ratio. These torque/speed ranges and gear ratios are preferably considered together by electric motor and transmission designers to narrow the field of alternatives. Referring to FIG. 3, in one embodiment, an electric motor subsystem design routine 60 includes receiving a defined design torque/speed space (Block 62) and exploring a third dimension, DC link voltage (Block 64). Each of these constraints is provided to electric motor designers who may perform cursory initial designs for competing electric motor technologies or, alternatively, competing electric motor designs may be generated utilizing a known electric motor by use of generally accepted scaling laws. In either case, an initial set of electric motor designs is formulated, including, for example, material content (mass and grade), phase voltage and current ratings, loss estimates, equivalent circuit model parameters, and geometric properties (Block 66). Corresponding electric motor control requirements are also preferably enumerated, and those that significantly affect cost are highlighted. Additionally, the mechanical aspects of each of the plurality of electric motor designs, including rotor shaft structural integrity and stator thermal performance, are investigated (Block 68). If the electric motor design fails to yield a satisfactory performance, further iterations may be carried out (Block 70).

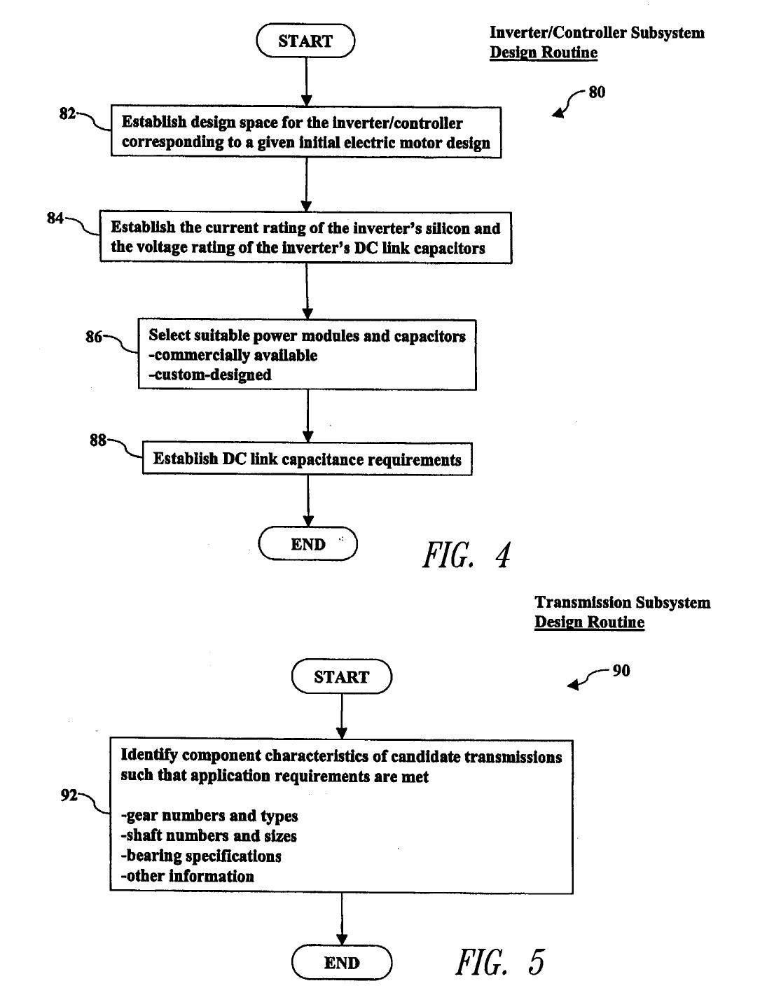

Referring to FIG. 4, in one embodiment, an inverter/controller subsystem design routine 80 includes establishing a design space for the inverter/controller 20 (FIG. 1), corresponding to a given initial electric motor design (Block 82). Specifically, the current rating of the inverter's silicon and the voltage rating of the inverter's DC link capacitors may be established (Block 84). Once these key design constraints are established, suitable power modules and capacitors are selected from those that are commercially available and those that may be custom designed (Block 86). In one embodiment, the inverter/controller subsystem design routine 80 takes into account the details of the power module and the gate drive circuitry to establish candidate designs that operate as closely as possible to the established power device ratings, leaving a minimum safety margin. This investigation also establishes the DC link capacitance requirements (Block 88). The inverter/controller subsystem design routine 80 may be carried out interactively and iteratively with the electric motor subsystem design routine 60 (FIG. 3).

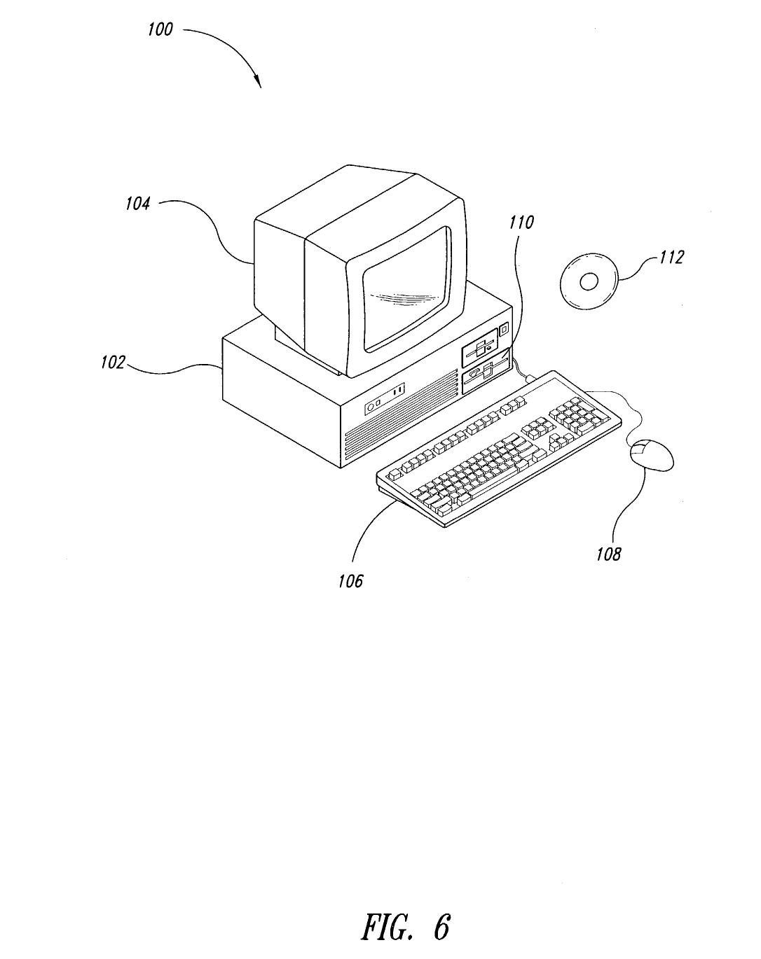

As a result of the electric power train sizing routine 40 (FIG. 2), and the initial interaction between electric motor designers and transmission designers, a reduced design space of transmission ratio, ratio step, and torque/speed is defined. Referring to FIG. 5, in one embodiment, the objective of a transmission subsystem design routine 90 is to identify the component characteristics of candidate transmissions 18 (FIG. 1), including the control characteristics of automatically-shifted transmissions, such that application requirements are met (Block 92). Component characteristics of interest may include gear numbers and types, shaft numbers and sizes, bearing specifications, and other information that allows the estimation of mass, packaging volume, and other quantities necessary to describe the dependent variables 24 (FIG. 1). The transmission subsystem design routine 90 preferably proceeds in parallel with the electric motor subsystem design routine 60 (FIG. 3) and the inverter/controller subsystem design routine 80 (FIG. 4), such that information regarding the feasibility of a given subsystem may be shared between the routines and changes in the remaining subsystems may be implemented.

High volume cost estimates may be utilized to estimate the cost per unit metric for each of the plurality of cost drivers 26 (FIG. 1). Given the values of the plurality of dependent variables 24 (FIG. 1) and the known or projected high volume costs, an average cost per unit may be determined for each of the plurality of cost drivers 26 for the electric motor 16 (FIG. 1), the transmission 18 (FIG. 1), and the inverter/controller 20 (FIG. 1). It should be noted that the total of the plurality of cost drivers 26 does not sum to the total of the cost of the given electric power train system 11 (FIG. 1). Thus, there may be a fixed portion of the cost of each of the plurality of subassemblies and a variable portion that is related to the plurality of cost drivers 26. For example, the $/cm² cm² of silicon plus the $/mF mF of capacitance does not equal the total inverter/controller cost. Aspects of the electric power train system 11 that remain constant for alternative designs are not reflected in the plurality of performance indices 30 (FIG. 1) generated. These performance indices 30, as discussed above, represent the weighted sums of the plurality of cost drivers 26, which represent the key elements of each of the plurality of subsystems comprising the electric power train 11.

FIG. 6 shows a computing system 100 having a computer 102, a user interface including a display 104, keyboard 106 and mouse 108. The computer 102 may employ the user interface elements to display a graphical user interface (GUI) to allow a user to interact with the computer 102. The computer 102 can be any conventional computer such as a personal computer, workstation, minicomputer, mainframe or supercomputer. The computer 102 includes a processor (not shown) to execute instructions and computer readable media for storing instructions, for example, memory (not shown) such as random access memory (RAM) and/or read only memory (ROM). The computer 102 also includes a drive 110 for reading removable computer readable media, such as floppy disks, CD-ROMs, Winchester disks, or optical disks 112. The memory or removable computer readable media can store instructions for causing the computer 102 to automatically perform the processes taught herein.

Although the present invention has been described with reference to preferred embodiments and examples thereof, other embodiments and examples may achieve the same results. Variations in and modifications to the present invention will be apparent to those of ordinary skill in the art and the following claims are intended to cover all such equivalent embodiments and examples.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Application No. 60/319,082, filed Jan. 16, 2002, are incorporated herein by reference, in their entirety.

1. A process for the optimization of the design of an electric power train system comprising a plurality of subsystems, the process comprising:
identifying a plurality of variables associated with the plurality of subsystems of the electric power train system, wherein the plurality of variables interact;
applying a plurality of constraints associated with the plurality of subsystems of the electric power train system to the plurality of variables;
manipulating the plurality of variables such that the plurality of constraints are met;
identifying a plurality of cost drivers associated with the plurality of subsystems of the electric power train system;
determining a plurality of weighting functions;
applying the plurality of weighting functions to the plurality of cost drivers to generate a plurality of weighted cost drivers associated with the plurality of subsystems of the electric power train system;
summing the plurality of weighted cost drivers to generate a performance index associated with the electric power train system; and
comparing a plurality of electric power train system designs utilizing a performance index associated with each, wherein a given electric power train system design with a relatively lower performance index has a relatively lower cost.

2. The process of claim 1, wherein the plurality of subsystems of the electric power train system comprise an electric motor, a transmission, and an inverter/controller.

3. The process of claim 1, wherein the plurality of variables comprise a plurality of independent variables.

4. The process of claim 3, wherein the plurality of independent variables comprise at least one variable selected from the group consisting of DC link voltage, coolant temperature, and motor speed range.

5. The process of claim 1, wherein the plurality of variables comprise a plurality of dependent variables.

6. The process of claim 5, wherein the plurality of dependent variables comprise at least one variable selected from the group consisting of peak current, switched voltage, temperature, motor technology, motor manufacturing technique, peak torque, maximum speed, fatigue life, package volume, and number of parts.

7. The process of claim 1, wherein the plurality of constraints comprise at least one constraint selected from the group consisting of driving cycles, original equipment manufacturer (OEM) vehicle data, packaging constraints, and environmental conditions.

8. The process of claim 1, wherein the plurality of cost drivers comprise at least one cost driver selected from the group consisting of insulated gate bipolar transistor (IGBT) silicon (Si) area, diode Si area, number of switch chips, number of diode chips, DC bus maximum voltage, DC bus capacitance, capacitor root-mean squared (RMS) ripple current, capacitor temperature rating, position sensor, mass of copper, mass of aluminum, mass of steel, mass of magnets, magnet material, rotor assembly, stator assembly, number of shafts, number of bearings, number of gears, shifting mechanism, and lubrication system.

9. A process for the optimization of the design of an electric power train system comprising a plurality of subsystems, including an electric motor, a transmission, and an inverter/controller, the process comprising:
identifying a plurality of cost drivers associated with the electric motor;
identifying a plurality of cost drivers associated with the transmission;
identifying a plurality of cost drivers associated with the inverter/controller;
determining a plurality of weighting functions;
applying the plurality of weighting functions to the plurality of cost drivers;
summing the plurality of weighted cost drivers to generate a performance index associated with the electric power train system; and
comparing a plurality of electric power train systems utilizing a plurality of performance indices, wherein a given electric power train system design with a relatively lower performance index has a relatively lower cost.

10. The process of claim 9, wherein the plurality of cost drivers associated with the electric motor comprise at least one cost driver selected from the group consisting of mass of copper, mass of aluminum, mass of steel, mass of magnets, magnet material, rotor assembly, and stator assembly.

11. The process of claim 9, wherein the plurality of cost drivers associated with the transmission comprise at least one cost driver selected from the group consisting of number of shafts, number of bearings, number of gears, shifting mechanism, and lubrication system.

12. The process of claim 9, wherein the plurality of cost drivers associated with the inverter/controller comprise at least one cost driver selected from the group consisting of insulated gate bipolar transistor (IGBT) silicon (Si) area, diode Si area, number of switch chips, number of diode chips, DC bus maximum voltage, DC bus capacitance, capacitor root-mean-squared (RMS) ripple current, capacitor temperature rating, and position sensor.

13. The process of claim 9, wherein the electric power train system is suitable for use in an electric vehicle.
